(19) United States
(12) Patent Application Publication
(10) Pub. No.: US 2026/0213665 A1
(43) Pub. Date: Jul. 23, 2026

(54) DC-DC CONVERTER AND SWITCHING POWER SUPPLY

(71) Applicant: Murata Manufacturing Co., Ltd., Nagaokakyo-shi (JP)

(72) Inventors: Takayoshi NISHIYAMA, Nagaokakyo-shi (JP); Takuji YOKAWA, Nagaokakyo-shi (JP); Hajime SHIJI, Nagaokakyo-shi (JP); Eito MOROMIZATO, Nagaokakyo-shi (JP)

(21) Appl. No.: 19/572,042

(22) Filed: Mar. 19, 2026

Related U.S. Application Data
(63) Continuation of application No. PCT/JP2024/031320, filed on Aug. 30, 2024.

(30) Foreign Application Priority Data
Sep. 27, 2023 (JP) 2023-165287

(51) Int. Cl. H02M 3/335; H02M 1/00; H02M 3/00

(52) U.S. Cl. CPC H02M 3/33569; H02M 1/0064; H02M 3/01

(57) ABSTRACT

A DC-DC converter includes first and second switches, an LC series resonant circuit, a conductor, first and second windings that are magnetically positively coupled to each other, and first and second rectifiers. The first winding and the second winding are magnetically positively coupled to each other.

### CROSS REFERENCE TO RELATED APPLICATIONS

This application claims the benefit of priority to Japanese Patent Application No. 2023-165287 filed on Sep. 27, 2023 and is a Continuation Application of PCT Application No. PCT/JP2024/031320 filed on Aug. 30, 2024. The entire contents of each application are hereby incorporated herein by reference.

### BACKGROUND OF THE INVENTION

### 1. Field of the Invention

The present invention relates to DC-DC converters and switching power supplies.

### 2. Description of the Related Art

As an example of known DC-DC converters, a DC-DC converter described in Japanese Patent No. 4649299 is known. The DC-DC converter described in Japanese Patent No. 4649299 receives a voltage Vin from a DC power supply 10 and outputs a voltage Vout. The DC-DC converter described in Japanese Patent No. 4649299 includes switching elements 11 and 12, a capacitor 13, inductance elements 14 and 15, diodes 16 and 17, and a smoothing capacitor 18. The inductance element 14 includes a primary winding 141, a secondary winding 142, and output voltage terminals 201 and 202. The turns ratio of the primary winding 141 to the secondary winding 142 is n:1. The inductance element 15 includes a primary winding 151 and a secondary winding 152. The turns ratio of the primary winding 151 to the secondary winding 152 is n:1.

One end of a series circuit including the switching elements 11 and 12 is connected to the positive terminal of the DC power supply 10. The other end of the series circuit including the switching elements 11 and 12 is connected to the negative terminal of the DC power supply 10.

The switching elements 11 and 12 are controlled such that when one is on, the other is off. The connection point of the switching elements 11 and 12 is connected to the negative terminal of the DC power supply via a series circuit including the capacitor 13, the primary winding 141 of the inductance element 14, and the primary winding 151 of the inductance element 15.

One end of the secondary winding 142 of the inductance element 14 is connected to the cathode of the diode 16. The other end of the secondary winding 142 of the inductance element 14 is connected to one end of the secondary winding 152 of the inductance element 15. The other end of the secondary winding 152 of the inductance element 15 is connected to the cathode of the diode 17. The connection point of the other end of the secondary winding 142 of the inductance element 14 and the one end of the secondary winding 152 of the inductance element 15 is connected to the output voltage terminal 201. The anodes of the diodes 16 and 17 are both connected to the output voltage terminal 202. The smoothing capacitor 18 is connected between the output voltage terminals 201 and 202. The voltage Vout output by the DC-DC converter is expressed by D× (1−D)×Vin/n, where D is the ratio of the on-period of the switching element 11 to the switching cycle (the sum of the on-period and off-period of the switching element 11).

In the configuration described above, when it is intended to increase the step-down ratio of the DC-DC converter, the number of turns of the primary winding needs to be increased. For example, in a case in which D=0.5, when it is intended to set the step-down ratio to 1/8 (Vout=1/8Vin), n=2 is set. As a result, the turns ratio of the primary winding 141 to the secondary winding 142 is 2:1, and the turns ratio of the primary winding 151 to the secondary winding 152 is 2:1. Accordingly, the turns ratio of the total of the primary windings 141 and 151 to the secondary winding 142 to the secondary windings 152 is 4:1:1. When the number of turns of the primary winding increases, the resistance of the primary winding increases, and as a result, the copper loss due to the primary winding increases.

When the switching element 11 is on and the switching element 12 is off, no current flows through the secondary winding 142 of the inductance element 14 and the diode 16, whereas current mainly flows through the secondary winding 152 of the inductance element 15 and the diode 17. When the switching element 11 is off and the switching element 12 is on, current mainly flows through the secondary winding 142 of the inductance element 14, whereas no current flows through the secondary winding 152 of the inductance element 15. As such, current flows through the secondary winding 142 of the inductance element 14 mainly during a particular period (a first period), and current flows through the secondary winding 152 of the inductance element 15 mainly during a different particular period (a second period). That is, current flow is concentrated in separate periods. Thus, with respect to a given output current, the effective value of the current Irec2 flowing through the secondary winding 142 of the inductance element 14 becomes relatively large during the first period. Similarly, the effective value of the current Irec1 flowing through the secondary winding 152 of the inductance element 15 becomes relatively large during the second period. As a result, the copper loss due to the secondary winding 142 of the inductance element 14 and the copper loss due to the secondary winding 152 of the inductance element 15 become large.

### SUMMARY OF THE INVENTION

Example embodiments of the present invention provide DC-DC converters and switching power supplies that each reduce copper loss.

A DC-DC converter according to an example embodiment of the present invention includes a first switch including a first end and a second end, the first end being connected to a DC power supply, a second switch including a third end and a fourth end, the third end being connected to the second end, an LC series resonant circuit including a fifth end and a sixth end, the fifth end being connected to a connection point between the second end and the third end, a conductor including a seventh end and an eighth end, a first winding including a ninth end and a tenth end, a second winding including an eleventh end and a twelfth end, a first rectifier including a thirteenth end and a fourteenth end, and a second rectifier including a fifteenth end and a sixteenth end, the fifteenth end being connected to the thirteenth end. The first winding and the second winding are magnetically positively coupled to each other. The sixth end is connected to the seventh end. The eighth end is connected to the ninth end and the fourteenth end. The tenth end is connected to the eleventh end. The twelfth end is connected to the fourth end and the sixteenth end.

Because the eighth end of the conductor is connected to the ninth end of the first winding and the fourteenth end of the first rectifier, the first winding also corresponds to a portion of the primary winding. Accordingly, the DC-DC converter according to the above-described example embodiment of the present invention can increase the step-down ratio of the DC-DC converter without increasing the number of turns of the primary winding. As a result, the DC-DC converter according to the above-described example embodiment of the present invention can reduce copper loss due to the primary winding.

DC-DC converters and switching power supplies according to example embodiments of the present invention are each able to reduce copper loss.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a circuit diagram illustrating a switching power supply 20 including a DC-DC converter 21 as well as a load resistance RL1 according to an example embodiment of the present invention.

FIG. 2 illustrates an example of a drain D-source S voltage v1 of a first switch S1, a drain D-source S voltage v2 of a second switch S2, a first control signal CS1, a second control signal CS2, a current i1 flowing through a capacitor C, an excitation current flowing im through a first excitation inductance Lm1, a current iD1 flowing through a first diode D1, and a current iD2 flowing through a second diode D2 according to an example embodiment of the present invention.

FIG. 3 is a sectional view schematically illustrating the structure of a transformer TR1, as well as the connections of the transformer TR1 according to an example embodiment of the present invention.

FIG. 4 is a plan view schematically illustrating the structure of a first core CO1 according to an example embodiment of the present invention.

FIG. 5 is an operational diagram illustrating current flowing through the switching power supply 20 and the load resistance RL1 in a first period P1 according to an example embodiment of the present invention.

FIG. 6 is an operational diagram illustrating current flowing through the switching power supply 20 and the load resistance RL1 in a second period P2 according to an example embodiment of the present invention.

FIG. 7 is a sectional view schematically illustrating the structure of a transformer TR2, as well as the connections of the transformer TR2 according to an example embodiment of the present invention.

FIG. 8 is a plan view schematically illustrating the structure of a first core CO1 according to an example embodiment of the present invention.

FIG. 9 is a circuit diagram illustrating a switching power supply 20b including a DC-DC converter 21b, as well as a load resistance RL1 according to an example embodiment of the present invention.

FIG. 10 is a circuit diagram illustrating a switching power supply 20c including a DC-DC converter 21c, as well as load resistances RL1 and RL2 according to an example embodiment of the present invention.

FIG. 11 is a circuit diagram illustrating a switching power supply 20d including a DC-DC converter 21d, as well as load resistances RL1 and RL2 according to an example embodiment of the FIG. 12 is a circuit diagram illustrating a switching power supply 20e including a DC-DC converter 21e, as well as a load resistance RL1 according to an example embodiment of the present invention.

FIG. 13 is a sectional view schematically illustrating the structure of a transformer TR4, as well as the connections of the transformer TR4 according to an example embodiment of the present invention.

FIG. 14 is a plan view schematically illustrating the structure of a first core CO1 according to an example embodiment of the present invention.

FIG. 15 is a sectional view schematically illustrating the structure of a transformer TR6, as well as the connections of the transformer TR6 according to an example embodiment of the present invention.

FIG. 16 is a plan view schematically illustrating the structure of a first core CO1 according to an example embodiment of the present invention.

FIG. 17 is a circuit diagram illustrating a switching power supply 20g including a DC-DC converter 21g, as well as a load resistance RL1, according to an example embodiment of the present invention.

FIG. 18 is a sectional view schematically illustrating the structure of a transformer TR7, as well as the connections of the transformer TR7 according to an example embodiment of the

FIG. 19 is a plan view schematically illustrating the structure of a second core CO2 according to an example embodiment of the present invention.

FIG. 20 is a sectional view schematically illustrating the structure of a transformer TR8, as well as the connections of the transformer TR8 according to an example embodiment of the present invention.

FIG. 21 is a plan view schematically illustrating the structure of a second core CO2 according to an example embodiment of the present invention.

FIG. 22 is a circuit diagram illustrating a switching circuit SW of a ninth modification according to an example embodiment of the present invention.

FIG. 23 is a circuit diagram illustrating a switching circuit SW of a tenth modification according to an example embodiment of the present invention.

FIG. 24 is a circuit diagram illustrating a modification of a first rectifier according to an example embodiment of the present invention.

### DETAILED DESCRIPTION OF THE EXAMPLE EMBODIMENTS

Example embodiments of the present invention will be described in detail below with reference to the drawings.

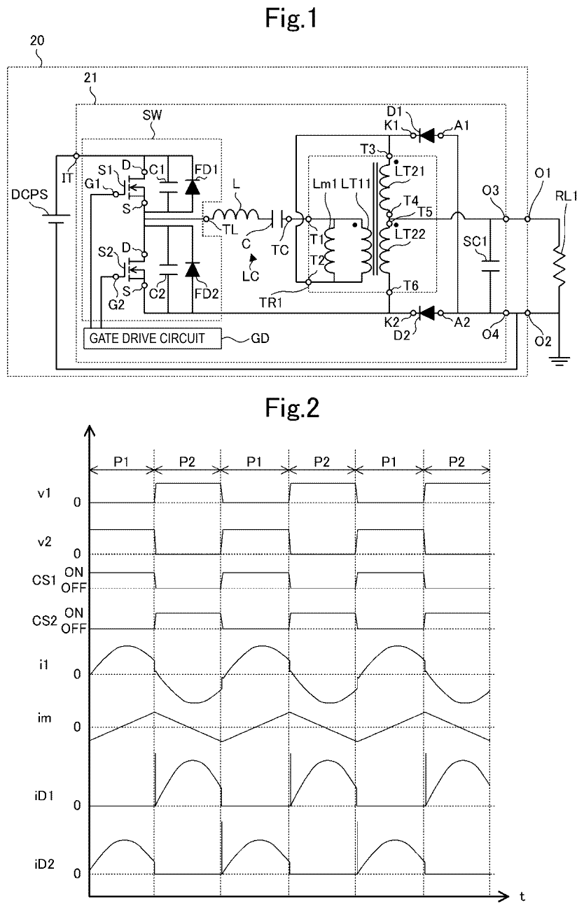

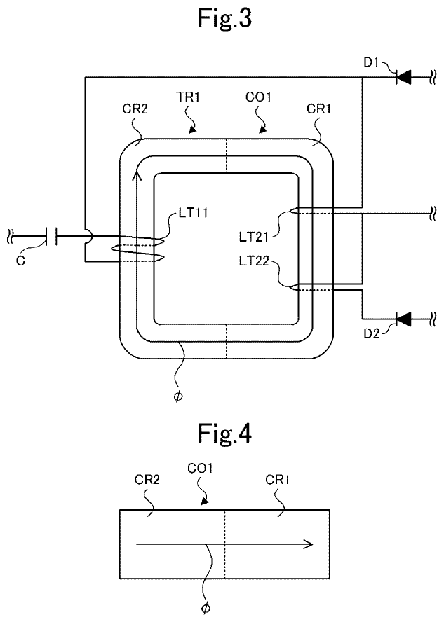

A switching power supply 20 including a DC-DC converter 21 according to a first example embodiment of the present invention is described below with reference to the drawings. FIG. 1 is a circuit diagram illustrating the switching power supply 20 including the DC-DC converter 21, as well as a load resistance RL1. In FIG. 1, the leakage inductance of a transformer TR1 is omitted. FIG. 2 illustrates an example of a drain D-source S voltage v1 of a first switch S1, a drain D-source S voltage v2 of a second switch S2, a first control signal CS1, a second control signal CS2, a current i1 flowing through the capacitor C, an excitation current im flowing through a first excitation inductance Lm1, a current iD1 flowing through a first diode D1, and a current iD2 flowing through a second diode D2. The horizontal axis in FIG. 2 represents time t. The vertical axis in FIG. 2 represents the drain D-source S voltage v1 of the first switch S1, the drain D-source S voltage v2 of the second switch S2, the first control signal CS1 for the first switch S1, the second control signal CS2 for the second switch S2, the current i1 flowing through the capacitor C, the excitation current im flowing through the first excitation inductance Lm1, the current iD1 flowing through the first diode D1, and the current iD2 flowing through the second diode D2. In FIG. 2, the positive direction of the current iD1 is a direction from a first anode A1 to a first cathode K1. In FIG. 2, the positive direction of the current iD2 is a direction from a second anode A2 to a second cathode K2. FIG. 3 is a sectional view schematically illustrating the structure of the transformer TR1, as well as the connections of the transformer TR1. FIG. 4 is a plan view schematically illustrating the structure of a first core CO1.

The switching power supply 20 is used to supply direct-current (DC) voltage to a load. As illustrated in FIG. 1, the switching power supply 20 includes a DC power supply DCPS, the DC-DC converter 21, and first output terminals O1 and O2.

The first output terminals O1 and O2 are connected to respective ends of the load resistance RL1. The first output terminal O2 is also connected to a ground potential. In the present example embodiment, the first output terminal O2 is connected to ground. The first output terminal O2 is not necessarily connected to ground. The load resistance RL1 is a specific example of a load. The load is not limited to a resistance component, but may also include a reactance component.

The DC power supply DCPS outputs a first DC voltage Vin. The negative terminal of the DC power supply DCPS is connected to the first output terminal O2. Consequently, the negative terminal of the DC power supply DCPS is connected to the ground potential. The positive terminal of the DC power supply DCPS is connected to the DC-DC converter 21. The DC power supply DCPS is, for example, a battery or an electric double-layer capacitor. The DC power supply DCPS is required to output a DC voltage. Accordingly, the DC power supply DCPS may be, for example, an AC-DC converter or a DC-DC converter.

The DC-DC converter 21 receives the first DC voltage Vin from the DC power supply DCPS. The DC-DC converter 21 is used to supply a second DC voltage Vout, which is different from the first DC voltage Vin, to a load. The DC-DC converter 21 includes a switching circuit SW, an LC series resonant circuit LC, a smoothing capacitor SC1, the first diode D1, the second diode D2, the transformer TR1, a gate drive circuit GD, an input terminal IT, and second output terminals O3 and O4. The smoothing capacitor SC1 need not be included.

The input terminal IT is connected to the positive terminal of the DC power supply DCPS. The second output terminals O3 and O4 are configured to output the second DC voltage Vout. The second output terminals O3 and O4 are respectively connected to the first output terminals O1 and O2.

The switching circuit SW includes the first switch S1 and the second switch S2. The first switch S1 is connected to the input terminal IT, the second switch S2, and a reactor L. In the present example embodiment, the first switch S1 is, for example, a metal-oxide-semiconductor field-effect transistor (MOSFET). The first switch S1 includes a parasitic capacitance C1 and a parasitic diode FD1. The drain D of the first switch S1 is connected to the positive terminal of the DC power supply DCPS via the input terminal IT. The source S of the first switch S1 is connected to the reactor L and the second switch S2. The drain D of the first switch S1 corresponds to a “first end”. The source S of the first switch S1 corresponds to a “second end”. The “first switch” is not limited to a MOSFET, but may be, for example, an element with a switching function, such as a bipolar transistor or an insulated gate bipolar transistor (IGBT).

The second switch S2 is connected to the first switch S1, the reactor L, the transformer TR1, and the second diode D2. In the present example embodiment, the second switch S2 is a MOSFET, for example. The second switch S2 includes a parasitic capacitance C2 and a parasitic diode FD2. The drain D of the second switch S2 is connected to the first switch S1 and the reactor L. The source S of the second switch S2 is connected to the transformer TR1 and the second diode D2. The drain D of the second switch S2 corresponds to a “third end”. The source S of the second switch S2 corresponds to a “fourth end”. The “second switch” of the present invention is not limited to a MOSFET, but may be, for example, an element with a switching function, such as a bipolar transistor or an IGBT.

The first control signal CS1 is applied to the gate G1 of the first switch S1 from the gate drive circuit GD. The first switch S1 is controlled to turn on or off by the first control signal CS1. As illustrated in FIG. 2, the first switch S1 alternates between an on-state and an off-state. In the on-state, the first switch S1 is closed. In the off-state, the first switch S1 is open. In the present example embodiment, the ratio of the on-period to the off-period of the first switch S1 is about 1:1, for example. Accordingly, the ratio of the on-period of the first switch S1 to the switching cycle (the sum of the on-period and the off-period of the first switch S1) is about 0.5, for example. The ratio of the on-period to the off-period of the first switch S1 is not limited to about 1:1.

The second control signal CS2 is applied to the gate G2 of the second switch S2 from the gate drive circuit GD. The second switch S2 is controlled to turn on or off by the second control signal CS2. The second switch S2 alternates between an on-state and an off-state. In the on-state, the second switch S2 is closed. In the off-state, the second switch S2 is open. The gate drive circuit GD generates the second control signal CS2 such that the second switch S2 is brought into the on-state when the first switch S1 is in the off-state. As a result, a first period P1, in which the first switch S1 is closed while the second switch S2 is open, and a second period P2, in which the second switch S2 is closed while the first switch S1 is closed, are repeated periodically. In the present example embodiment, the ratio of the on-period to the off-period of the second switch S2 is about 1:1, for example. As a result, the ratio of the first period P1 to the second period P2 is about 1:1. In addition to the first period P1 and the second period P2, a dead time period may be provided between the first period P1 and the second period P2. In the dead time period, the gate drive circuit GD may generate the first control signal CS1 and the second control signal CS2 such that the first switch S1 is brought into the off-state and the second switch S2 is brought into the off-state. By providing the dead time period, it is possible to more reliably prevent both the first switch S1 and the second switch S2 from being in the on-state at the same time. The ratio of the on-period to the off-period of the second switch S2 is not limited to about 1:1.

As illustrated in FIG. 1, the parasitic capacitance C1 is connected between the drain D and the source S of the first switch S1. The parasitic capacitance C1 reduces or prevents ringing when the first switch S1 is turned on or off. The first switch S1 can perform zero voltage switching (ZVS) during the dead time period due to the parasitic capacitance C1.

The parasitic diode FD1 is connected between the drain D and the source S of the first switch S1. The cathode of the parasitic diode FD1 is connected to the drain D of the first switch S1. The anode of the parasitic diode FD1 is connected to the source S of the first switch S1. Due to the parasitic diode FD1, when the first switch S1 is turned off, current returns from the anode to the cathode of the parasitic diode FD1. This configuration reduces or prevents current flowing from the source S to the drain D of the first switch S1, thus preventing breakdown of the first switch S1. A freewheeling diode may be provided separately from the first switch S1.

The parasitic capacitance C2 is connected between the drain D and the source S of the second switch S2. The parasitic capacitance C2 reduces or prevents ringing when the second switch S2 is turned on or off. The second switch S2 can perform ZVS during the dead time period due to the parasitic capacitance C2.

The parasitic diode FD2 is connected between the drain D and the source S of the second switch S2. The cathode of the parasitic diode FD2 is connected to the drain D of the second switch S2. The anode of the parasitic diode FD2 is connected to the source S of the second switch S2. Due to the parasitic diode FD2, when the second switch S2 is turned off, current returns from the anode to the cathode of the parasitic diode FD2. This configuration reduces or prevents current flowing from the source S to the drain D of the second switch S2, thus preventing breakdown of the second switch S2. A freewheeling diode may be provided separately from the second switch S2.

The LC series resonant circuit LC includes the reactor L and the capacitor C. The reactor L is connected to a connection point between the source S of the first switch S1 and the drain D of the second switch S2 and to the capacitor C. The capacitor C is connected to the reactor L and the transformer TR1. The capacitor C is connected in series with the reactor L. The first switch S1 and the second switch S2 can perform soft switching by current resonance between the reactor L and the capacitor C. The end TL of the reactor L connected to the connection point between the source S of the first switch S1 and the drain D of the second switch S2 corresponds to a “fifth end”. The end TC of the capacitor C connected to the transformer TR1 corresponds to a “sixth end”.

In the circuit diagram illustrated in FIG. 1, the transformer TR1 includes the first excitation inductance Lm1 and windings LT11, LT21, and LT22. The windings LT11, LT21, and LT22 are magnetically coupled. The first excitation inductance Lm1 is an inductance that generates a magnetic flux (that links all of the windings LT11, LT21, and LT22. In the present example embodiment, the turns ratio of the winding LT11 to the winding LT21 to the winding LT22 is, for example, about n:1:1, where n=2. However, n is not limited to about 2. The turns ratio of the winding LT11 to the winding LT21 to the winding LT22 need not be about n:1:1.

In the sectional view illustrated in FIG. 3, the transformer TR1 includes the first core CO1 and the windings LT11, LT21, and LT22. The material of the first core CO1 is a magnetic material. The first core CO1 includes a first core portion CR1 and a second core portion CR2. The winding LT11 is wound around the second core portion CR2. The windings LT21 and LT22 are each wound around the first core portion CR1. As illustrated in FIGS. 3 and 4, the first core CO1 defines a magnetic path. In the present example embodiment, the area of a cross-section of the second core portion CR2 perpendicular or substantially perpendicular to the magnetic path is equal or substantially equal to the area of a cross-section of the first core portion CR1 perpendicular or substantially perpendicular to the magnetic path. An air gap may be provided between the first core portion CR1 and the second core portion CR2.

As illustrated in FIG. 1, one end T1 of the winding LT11 is connected to an end TC of the capacitor C. The other end T2 of the winding LT11 is connected to the winding LT21 and the first diode D1. As a result, the windings LT11 and LT21 are not isolated from each other. The winding LT11 corresponds to a “conductor” and a “third winding”. The one end T1 of the winding LT11 corresponds to a “seventh end”. The other end T2 of the winding LT11 corresponds to an “eighth end”.

One end T3 of the winding LT21 is connected to the other end T2 of the winding LT11 and the first diode D1. The other end T4 of the winding LT21 is connected to the winding LT22 and the second output terminal O3. The winding LT21 corresponds to a “first winding”. The one end T3 of the winding LT21 corresponds to a “ninth end”. The other end T4 of the winding LT21 corresponds to a “tenth end”.

One end T5 of the winding LT22 is connected to the other end T4 of the winding LT21 and the second output terminal O3. The other end T6 of the winding LT22 is connected to the source S of the second switch S2 and the second diode D2. The winding LT22 corresponds to a “second winding”. The one end T5 of the winding LT22 corresponds to an “eleventh end”. The other end T6 of the winding LT22 corresponds to a “twelfth end”.

As illustrated in FIG. 3, in the transformer TR1, the direction of the magnetic flux φ generated when current flows from the one end T1 of the winding LT11 to the other end T2 of the winding LT11 coincides with the direction of the magnetic flux φ generated when current flows from the one end T3 of the winding LT21 to the other end T4 of the winding LT21, and with the direction of the magnetic flux φ generated when current flows from the one end T5 of the winding LT22 to the other end T6 of the winding LT22. As a result, the windings LT11, LT21, and LT22 are magnetically positively coupled to each other. In other words, the coupling coefficient between the windings LT11 and LT21 is positive. The coupling coefficient between the windings LT11 and LT22 is positive. The coupling coefficient between the windings LT21 and LT22 is positive.

As illustrated in FIG. 1, the first diode D1 includes the first anode A1 and the first cathode K1. The first cathode K1 is connected to the other end T2 of the winding LT11 and the one end T3 of the winding LT21. The first anode A1 is connected to the second diode D2 and the second output terminal O4. The first diode D1 corresponds to a “first rectifier”. The first anode A1 corresponds to a “thirteenth end”. The first cathode K1 corresponds to a “fourteenth end”.

The second diode D2 includes the second anode A2 and the second cathode K2. The second cathode K2 is connected to the source S of the second switch S2 and the other end T6 of the winding LT22. The second anode A2 is connected to the first anode A1 and the second output terminal O4. The second diode D2 corresponds to a “second rectifier”. The second anode A2 corresponds to a “fifteenth end”. The second cathode corresponds to a “sixteenth end”.

The smoothing capacitor SC1 is connected to the second output terminals O3 and O4. That is, the smoothing capacitor SC1 is connected to a connection point between the other end T4 of the winding LT21 and the winding LT22, and to a connection point between the first anode A1 and the second anode A2.

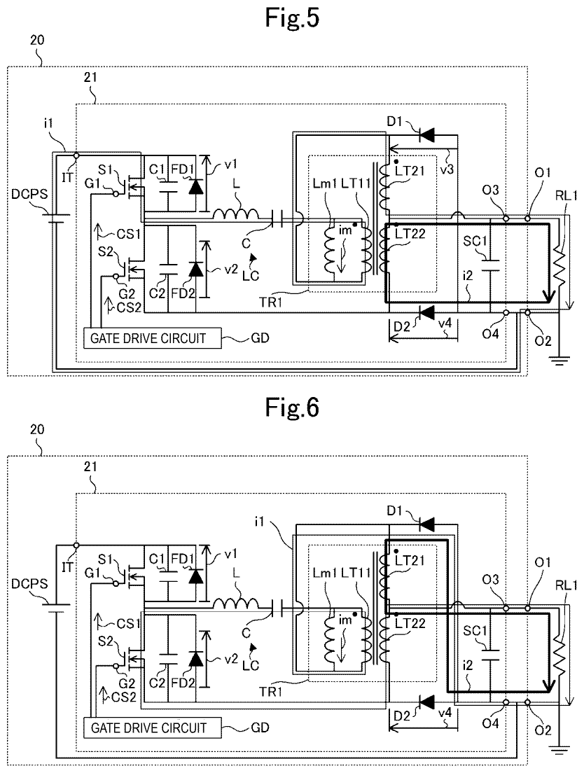

Next, the operation of the DC-DC converter 21 is described. FIG. 5 is an operational diagram illustrating current flowing through the switching power supply 20 and the load resistance RL1 in the first period P1. FIG. 6 is an operational diagram illustrating current flowing through the switching power supply 20 and the load resistance RL1 in the second period P2.

As illustrated in FIG. 5, in the first period P1, the current i1 flows through the following path: ground, the DC power supply DCPS, the input terminal IT, the first switch S1, the reactor L, the capacitor C, the windings LT11 and LT21, the second output terminal O3, the first output terminal O1, the load resistance RL1, and ground. In the first period P1, the capacitor C is charged by the current i1. That is, the current i1 is the charging current of the capacitor C during the first period P1. When the current i1 flows through the winding LT11, the excitation current im flows through the first excitation inductance Lm1. At this time, because the windings LT11 and LT22 are magnetically coupled, a current i2 flows through the winding LT22. The current i2 flows through the following path: the winding LT22, the second output terminal O3, the first output terminal O1, the load resistance RL1, the first output terminal O2, the second output terminal O4, the second diode D2, and the winding LT22. In the first period P1, because the currents i1 and i2 flow, the electric potential at the one end T3 of the winding LT21 differs from the electric potential at the source S of the second switch S2. More specifically, in the first period P1, the electric potential at the one end T3 of the winding LT21 is higher than the electric potential at the source S of the second switch S2.

As illustrated in FIG. 2, in the first period P1, no current flows through the first diode D1. Conversely, in the first period P1, current flows through the second diode D2.

As illustrated in FIG. 6, in the second period P2, the capacitor C discharges. The current i1 is the discharge current of the capacitor C during the second period P2. In the second period P2, the current i1 flows through the following path: the capacitor C, the second switch S2, the winding LT22, the second output terminal O3, the first output terminal O1, the load resistance RL1, the first output terminal O2, the second output terminal O4, the first diode D1, the winding LT11, and the capacitor C. When the current i1 flows through the winding LT11, the excitation current im flows through the first excitation inductance Lm1. At this time, because the windings LT11 and LT21 are magnetically coupled, the current i2 flows through the winding LT21. The current i2 flows through the following path: the winding LT21, the second output terminal O3, the first output terminal O1, the load resistance RL1, the first output terminal O2, the first diode D1, and the winding LT21. In the second period P2, because the currents i1 and i2 flow, the electric potential at the one end T3 of the winding LT21 differs from the electric potential at the source S of the second switch S2. More specifically, in the second period P2, the electric potential at the one end T3 of the winding LT21 is lower than the electric potential at the drain D of the first switch S1.

As illustrated in FIG. 2, in the second period P2, current flows through the first diode D1. Conversely, in the second period P2, no current flows through the second diode D2.

In the present example embodiment, the second DC voltage Vout is denoted by the following Equation 1 using the first DC voltage Vin and n:

$$Vout = \frac{Vin}{4 + 2 n} \qquad Equation 1$$

The DC-DC converter 21 can reduce copper loss. More specifically, the second DC voltage Vout is denoted by Equation 1 listed above using the first DC voltage Vin and n. As a result, for example, in the case in which the ratio of the on-period of the first switch S1 to the switching cycle is about 0.5, when the step-down ratio of the DC-DC converter 21 is to be about 1/8 (Vout=1/8Vin), then n=2. Accordingly, the turns ratio of the winding LT11 to the winding LT21 to the winding LT22 is about 2:1:1. In the case of the DC-DC converter described in Japanese Patent No. 4649299, the turns ratio of the total of the primary windings 141 and 151 to the secondary winding 142 to the secondary winding 152 is 4:1:1. As compared to the primary windings 141 and 151 in the DC-DC converter described in Japanese Patent No. 4649299, the number of turns of the winding LT11 is reduced. The DC-DC converter 21 of the present example embodiment thus can lower the resistance of the winding LT11 by reducing the number of turns of the winding LT11. As a result, the DC-DC converter 21 of the present example embodiment can reduce copper loss due to the winding LT11.

Additionally, the DC-DC converter 21 can further reduce copper loss. More specifically, in the first period P1, current flows through both of the windings LT21 and LT22. At this time, the current flowing through the winding LT21 flows in the same direction as the current flowing through the winding LT22 with respect to the load resistance RL1. In other words, in the first period P1, the current flowing through the load resistance RL1 is the sum of the current flowing through the winding LT21 and the current flowing through the winding LT22. In the second period P2, current flows through both the windings LT21 and LT22. At this time, the current flowing through the winding LT21 flows in the same direction as the current flowing through the winding LT22 with respect to the load resistance RL1. In other words, in the second period P2 as well, the current flowing through the load resistance RL1 is the sum of the current flowing through the winding LT21 and the current flowing through the winding LT22. Accordingly, current flows through the windings LT21 and LT22 without being concentrated in separate periods. As a result, it is unnecessary to excessively increase the effective value of the current flowing through the winding LT21 and the effective value of the current flowing through the winding LT22 for a given output current. The DC-DC converter 21 of the present example embodiment thus can reduce copper loss due to the windings LT21 and LT22.

Additionally, the DC-DC converter 21 can extend the life of the second diode D2. More specifically, in the first period P1, the current i1 flowing through the capacitor C does not flow through the second diode D2. In the second period P2, no current flows through the second diode D2. As a result, the effective value of the current flowing through the second diode D2 is relatively small. This reduces or prevents the loss generated by the second diode D2 and the amount of heat generated by the second diode D2. Accordingly, the temperature of the second diode D2 can be maintained relatively low, leading to an extended life of the second diode D2.

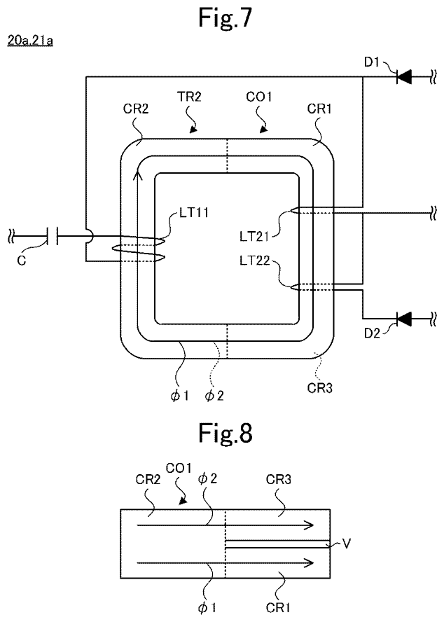

A DC-DC converter 21a and a switching power supply 20a according to a first modification of an example embodiment of the present invention are described below with reference to the drawings. FIG. 7 is a sectional view schematically illustrating the structure of a transformer TR2, as well as the connections of the transformer TR2. FIG. 8 is a plan view schematically illustrating the structure of a first core CO1. The following description of the DC-DC converter 21a and the switching power supply 20a according to the first modification mainly focuses on features that differ from the DC-DC converter 21 and the switching power supply 20 according to the first example embodiment, and the other descriptions thereof will be omitted.

The DC-DC converter 21a and the switching power supply 20a according to the first modification differ from the DC-DC converter 21 and switching power supply 20 according to the first example embodiment in that a transformer TR2 is included instead of the transformer TR1.

As illustrated in FIG. 7, the first core CO1 further includes a third core portion CR3. This means that the first core C01 includes three core portions. The winding LT22 is wound around the third core portion CR3. This means that the windings LT11, LT21, and LT22 are each wound around a respective different one of the three core portions of the first core CO1. As illustrated in FIG. 8, a void V is provided between the first core portion CR1 and the third core portion CR3. As illustrated in FIGS. 7 and 8, the first core CO1 defines a magnetic path. More specifically, the first core portion CR1 and the second core portion CR2 define a magnetic path through which a magnetic flux φ1 flows. The second core portion CR2 and the third core portion CR3 define a magnetic path through which a magnetic flux φ2 flows. The relationship φ=φ1+φ2 is satisfied. In the present modification, the area of a cross-section of the first core portion CR1 perpendicular or substantially perpendicular to the magnetic path and the area of a cross-section of the third core portion CR3 perpendicular or substantially perpendicular to the magnetic path are each about half the area of a cross-section of the second core portion CR2 perpendicular to the magnetic path. The sum of the area of the cross-section of the first core portion CR1 perpendicular or substantially perpendicular to the magnetic path and the area of the cross-section of the third core portion CR3 perpendicular or substantially perpendicular to the magnetic path is equal or substantially equal to the area of the cross-section of the second core portion CR2 perpendicular or substantially perpendicular to the magnetic path. Accordingly, the magnitude of the magnetic flux φ1 and the magnitude of the magnetic flux φ2 are each about half the magnetic flux φ. The first core CO1 may include four or more core portions.

In the present modification, the second DC voltage Vout is denoted by the following Equation 2 using the first DC voltage Vin and n:

$$Vout = \frac{Vin}{4 + 4 n} \qquad Equation 2$$

The DC-DC converter 21a and the switching power supply 20a described above also achieve the same or substantially the same advantageous effects as the DC-DC converter 21 and the switching power supply 20. Additionally, the DC-DC converter 21a can reduce copper loss when the step-down ratio is the same. More specifically, the magnitude of the magnetic flux φ1 and the magnitude of the magnetic flux 2 are each about half the magnetic flux φ. As a result, the induced electromotive forces generated in the windings LT21 and LT22 of the DC-DC converter 21a are about half the induced electromotive forces generated in the windings LT21 and LT22 of the DC-DC converter 21. In the DC-DC converter 21, to satisfy n=2, for example, it is necessary to set the number of turns of the winding LT11 to two, the number of turns of the winding LT21 to one, and the number of turns of the winding LT22 to one. By contrast, in the DC-DC converter 21a, to satisfy n=2, the number of turns of the winding LT11 is set to one, the number of turns of the winding LT21 to one, and the number of turns of the winding LT22 to one. This means that the number of turns of the winding LT11 can be about half the number of turns of the winding LT11 of the DC-DC converter 21. Accordingly, the DC-DC converter 21a can further lower the resistance of the winding LT11 by further reducing the number of turns of the winding LT11. As a result, the DC-DC converter 21a can further reduce copper loss due to the winding LT11.

In other words, when the number of turns of the winding LT11, the number of turns of the winding LT21, and the number of turns of the winding LT22 are set to be the same in both the DC-DC converter 21 and the DC-DC converter 21a, the step-down ratio of the DC-DC converter 21a is higher than the step-down ratio of the DC-DC converter 21. The DC-DC converter 21a can achieve a high step-down ratio without increasing the number of turns of the winding LT11 and without increasing the area of the cross-section of the core portion perpendicular or substantially perpendicular to the magnetic path.

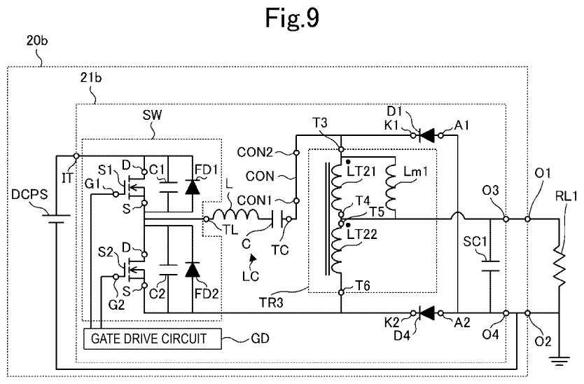

A DC-DC converter 21b and a switching power supply 20b according to a second modification of an example embodiment of the present invention are described below with reference to the drawings. FIG. 9 is a circuit diagram illustrating the switching power supply 20b including the DC-DC converter 21b, as well as a load resistance RL1. The following description of the DC-DC converter 21b and the switching power supply 20b according to the second modification mainly focuses on features that differ from the DC-DC converter 21 and the switching power supply 20 according to the first example embodiment, and the other descriptions thereof will be omitted.

The DC-DC converter 21b and the switching power supply 20b according to the second modification differ from the DC-DC converter 21 and switching power supply 20 according to the first example embodiment in that a transformer TR3 is included instead of the transformer TR1. As illustrated in FIG. 9, the transformer TR3 does not include a winding LT11.

In the present modification, the DC-DC converter 21b includes a conductor CON. One end CON1 of the conductor CON is connected to the end TC of the capacitor C. The other end CON2 of the conductor CON is connected to the winding LT21 and the first diode D1. The conductor CON in the present modification corresponds to a “conductor”. The one end CON1 of the conductor CON corresponds to a “seventh end”. The other end CON2 of the conductor CON corresponds to an “eighth end”.

The DC-DC converter 21b and the switching power supply 20b described above also achieve the same or substantially the same advantageous effects as the DC-DC converter 21 and the switching power supply 20. Furthermore, in the DC-DC converter 21b, although the winding LT11 is not included, the step-down ratio of the DC-DC converter 21b can be set to, for example, about 1/4 (Vout=1/4Vin). More specifically, by substituting n=0 into Equation 1, Vout=1/4Vin. Further, by eliminating the winding LT11, the size and cost of the DC-DC converter can be reduced.

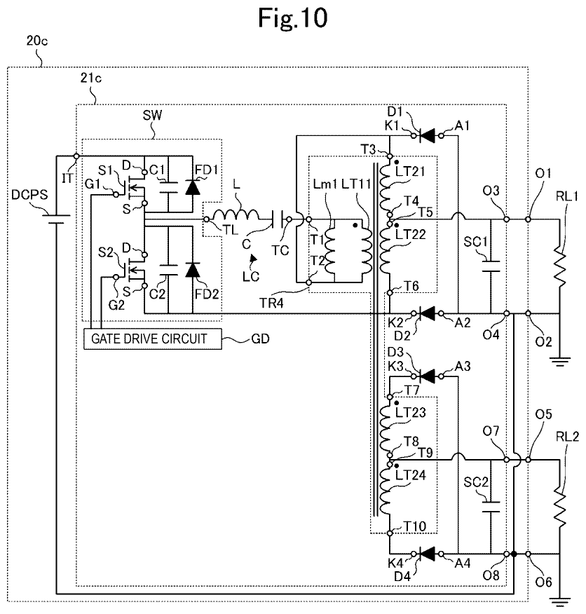

A DC-DC converter 21c and a switching power supply 20c according to a third modification of an example embodiment of the present invention are described below with reference to the drawings. FIG. 10 is a circuit diagram illustrating the switching power supply 20c including the DC-DC converter 21c, as well as load resistances RL1 and RL2. The following description of the DC-DC converter 21c and the switching power supply 20c according to the third modification mainly focuses on features that differ from the DC-DC converter 21 and the switching power supply 20 according to the first example embodiment, and the other descriptions thereof will be omitted.

The switching power supply 20c according to the third modification differs from the switching power supply 20 according to the first example embodiment in that third output terminals O5 and O6 are included, that the DC-DC converter 21c includes a transformer TR4 instead of the transformer TR1, and that the DC-DC converter 21c further includes a smoothing capacitor SC2, a third diode D3, a fourth diode D4, and fourth output terminals O7 and O8.

As illustrated in FIG. 10, the transformer TR4 further includes windings LT23 and LT24. The windings LT11, LT21, LT22, LT23, and LT24 are magnetically coupled. The first excitation inductance Lm1 is an inductance that generates a magnetic flux φ that links all of the windings LT11, LT21, LT22, LT23, and LT24. In the transformer TR4, the direction of the magnetic flux φ generated when current flows from the one end T1 of the winding LT11 to the other end T2 of the winding LT11 coincides with the direction of the magnetic flux φ generated when current flows from the one end T7 of the winding LT23 to the other end T8 of the winding LT23, and the direction of the magnetic flux φ generated when current flows from the one end T9 of the winding LT24 to the other end T10 of the winding LT24. As a result, the windings LT11, LT21, LT22, LT23 and LT24 are magnetically positively coupled to each other. In the present example embodiment, the turns ratio of the winding LT11 to the winding LT21 to the winding LT22 to the winding LT23 to the winding LT24 is, for example, about n:1:1:1:1. The turns ratio of the winding LT11 to the winding LT21 to the winding LT22 to the winding LT23 to the winding LT24 need not be n:1:1:1:1.

The third output terminals O5 and O6 are connected to respective ends of the load resistance RL2. The third output terminal O6 is connected to a ground potential. The third output terminals O5 and O6 are configured to output a third DC voltage that is different from the first DC voltage Vin. The load resistance RL2 is a specific example of a load. The load is not limited to a resistance component, but may also include a reactance component. The third DC voltage may be equal or substantially equal to the second DC voltage Vout or may be different from the second DC voltage Vout.

The third diode D3 includes a third anode A3 and a third cathode K3. The fourth diode D4 includes a fourth anode A4 and a fourth cathode K4. The connections of the smoothing capacitor SC2, the third diode D3, the fourth diode D4, the windings LT23 and LT24, the third output terminals O5 and O6, and the fourth output terminals O7 and O8 are the same or substantially the same as the connections of the smoothing capacitor SC1, the first diode D1, the second diode D2, the windings LT21 and LT22, the first output terminals O1 and O2, and the second output terminals O3 and O4, except that the third diode D3 and the winding LT23 are not connected to the other end T2 of the winding LT11, and that the fourth diode D4 and the winding LT24 are not connected to the source S of the second switch S2. Thus descriptions thereof are omitted. The third diode D3 corresponds to a “third rectifier”. The third anode A3 corresponds to a “twenty-first end”. The third cathode K3 corresponds to a “twenty-second end”, for example. The fourth diode D4 corresponds to a “fourth rectifier”. The fourth anode A4 corresponds to a “twenty-third end”. The fourth cathode K4 corresponds to a “twenty-fourth end”.

The winding LT23 corresponds to a “fourth winding”. The one end T7 of the winding LT23 corresponds to a “seventeenth end”. The other end T8 of the winding LT23 corresponds to an “eighteenth end”. The winding LT24 corresponds to a “fifth winding”. The one end T9 of the winding LT24 corresponds to a “nineteenth end”. The other end T10 of the winding LT24 corresponds to a “twentieth end”.

The DC-DC converter 21c and the switching power supply 20c described above also achieve the same or substantially the same advantageous effects as the DC-DC converter 21 and the switching power supply 20. Furthermore, the DC-DC converter 21c can output DC voltages in parallel.

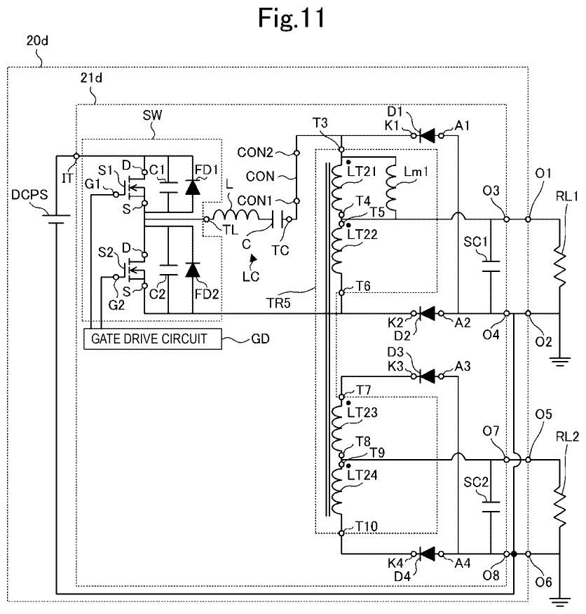

A DC-DC converter 21d and a switching power supply 20d according to a fourth modification of an example embodiment of the present invention are described below with reference to the drawings. FIG. 11 is a circuit diagram illustrating the switching power supply 20d including the DC-DC converter 21d, as well as load resistances RL1 and RL2. The following description of the DC-DC converter 21d and the switching power supply 20d according to the fourth modification mainly focuses on features that differ from the DC-DC converter 21c and the switching power supply 20c according to the third modification, and the other descriptions thereof will be omitted.

The DC-DC converter 21d and the switching power supply 20d according to the fourth modification differ from the DC-DC converter 21c and switching power supply 20c according to the third modification in that a transformer TR5 is included instead of the transformer TR4. As illustrated in FIG. 11, the transformer TR5 does not include a winding LT11.

In the present modification, the DC-DC converter 21d includes a conductor CON. One end CON1 of the conductor CON is connected to the end TC of the capacitor C. The other end CON2 of the conductor CON is connected to the winding LT21 and the first diode D1. The conductor CON in the present modification corresponds to a “conductor”. The one end CON1 of the conductor CON corresponds to a “seventh end”. The other end CON2 of the conductor CON corresponds to an “eighth end”.

The DC-DC converter 21d and the switching power supply 20d described above also achieve the same or substantially the same advantageous effects as the DC-DC converters 21b and 21c and the switching power supplies 20b and 20c.

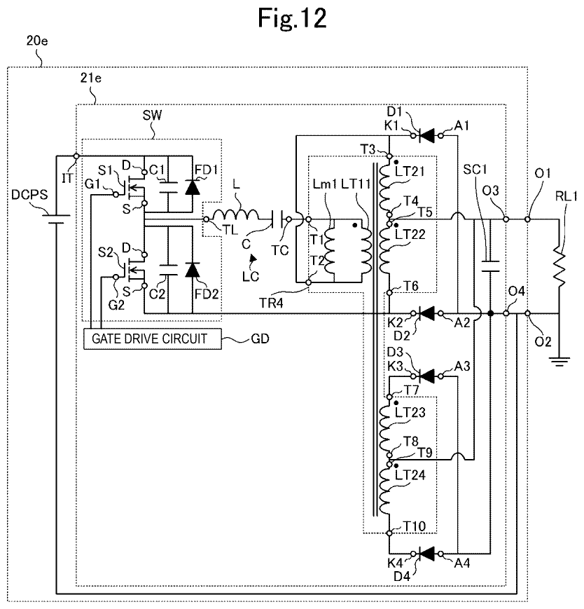

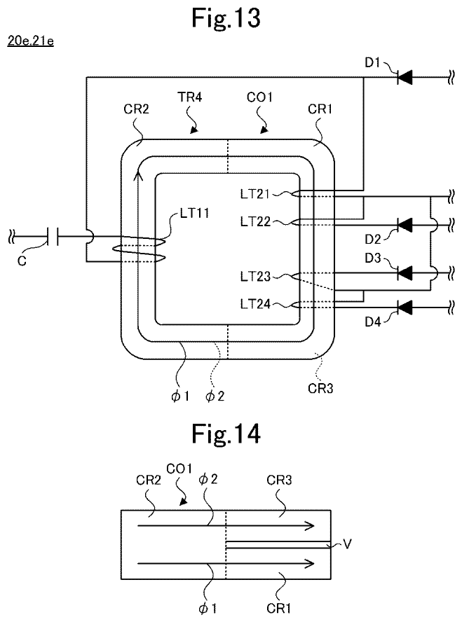

A DC-DC converter 21e and a switching power supply 20e according to a fifth modification of an example embodiment of the present invention are described below with reference to the drawings. FIG. 12 is a circuit diagram illustrating the switching power supply 20e including the DC-DC converter 21e, as well as a load resistance RL1. FIG. 13 is a sectional view schematically illustrating the structure of a transformer TR4, as well as the connections of the transformer TR4. FIG. 14 is a plan view schematically illustrating the structure of a first core CO1. The following description of the DC-DC converter 21e and the switching power supply 20e according to the fifth modification mainly focuses on features that differ from the DC-DC converter 21c and the switching power supply 20c according to the third modification, and the other descriptions thereof will be omitted.

The switching power supply 20e according to the fifth modification differs from the switching power supply 20c according to the third modification in that third output terminals O5 and O6 are not included, and that the DC-DC converter 21e does not include a smoothing capacitor SC2 and fourth output terminals O7 and O8. In the present modification, the third DC voltage output from the third output terminals O5 and O6 is equal or substantially equal to the second DC voltage Vout.

As illustrated in FIG. 12, a connection point between the other end T8 of the winding LT23 and the one end T9 of the winding LT24 is connected to the second output terminal O3. That is, the connection point between the other end T8 of the winding LT23 and the one end T9 of the winding LT24 is connected to a connection point between the other end T4 of the winding LT21 and the one end T5 of the winding LT22. A connection point between the third anode A3 and the fourth anode A4 is connected to the second output terminal O4. That is, the connection point between the third anode A3 and the fourth anode A4 is connected to a connection point between the first anode A1 and the second anode A2.

As illustrated in FIG. 13, the first core CO1 further includes a third core portion CR3. The windings LT23 and LT24 are each wound around the third core portion CR3. As illustrated in FIG. 14, a void V is provided between the first core portion CR1 and the third core portion CR3. As illustrated in FIGS. 13 and 14, the first core CO1 defines a magnetic path. More specifically, the first core portion CR1 and the second core portion CR2 define a magnetic path through which a magnetic flux φ1 flows. The second core portion CR2 and the third core portion CR3 define a magnetic path through which a magnetic flux φ2 flows. The relationship φ=φ1+φ2 is satisfied. In the present modification, the area of a cross-section of the first core portion CR1 perpendicular or substantially perpendicular to the magnetic path and the area of a cross-section of the third core portion CR3 perpendicular or substantially perpendicular to the magnetic path are each about half the area of a cross-section of the second core portion CR2 perpendicular or substantially perpendicular to the magnetic path. The sum of the area of the cross-section of the first core portion CR1 perpendicular or substantially perpendicular to the magnetic path and the area of the cross-section of the third core portion CR3 perpendicular or substantially perpendicular to the magnetic path is equal or substantially equal to the area of the cross-section of the second core portion CR2 perpendicular or substantially perpendicular to the magnetic path. Accordingly, the magnitude of the magnetic flux φ1 and the magnitude of the magnetic flux φ2 are each about half the magnetic flux φ. The third core portion CR3 corresponds to a “second core portion”.

The DC-DC converter 21e and the switching power supply 20e described above also achieve the same or substantially the same advantageous effects as the DC-DC converters 21 and 21a and the switching power supplies 20 and 20a. Specifically, the DC-DC converter 21e can further reduce copper loss due to the winding LT11. In other words, the DC-DC converter 21e can achieve a high step-down ratio without increasing the number of turns of the winding LT11 and without increasing the area of the cross-section of the core portion perpendicular or substantially perpendicular to the magnetic path.

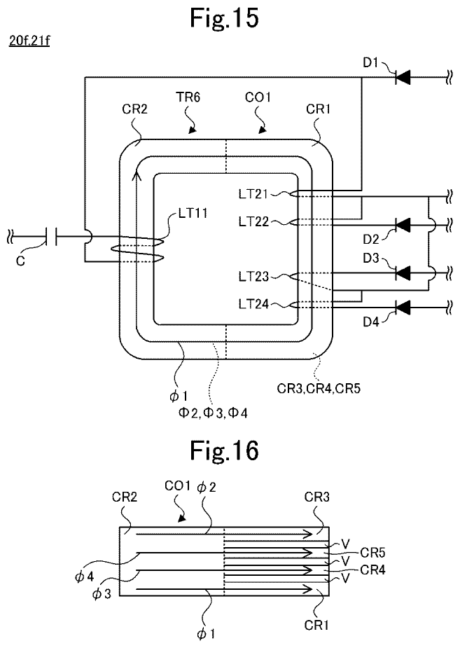

A DC-DC converter 21f and a switching power supply 20f according to a sixth modification of an example embodiment of the present invention are described below with reference to the drawings. FIG. 15 is a sectional view schematically illustrating the structure of a transformer TR6, as well as the connections of the transformer TR6. FIG. 16 is a plan view schematically illustrating the structure of a first core CO1. The following description of the DC-DC converter 21f according to the sixth modification mainly focuses on features that differ from the DC-DC converter 21e and the switching power supply 20e according to the fifth modification, and the other descriptions thereof will be omitted.

The DC-DC converter 21f and the switching power supply 20f according to the sixth modification differ from the DC-DC converter 21e and switching power supply 20e according to the fifth modification in that a transformer TR6 is included instead of the transformer TR4.

As illustrated in FIG. 15, the first core CO1 further includes a fourth core portion CR4 and a fifth core portion CR5. This means that the first core CO1 includes five core portions. The winding LT22 is wound around the fourth core portion CR4. The winding LT23 is wound around the fifth core portion CR5. The winding LT24 is wound around the third core portion CR3. This means that the windings LT11, LT21, LT22, LT23, and LT24 are each wound around a respective different one of the five core portions. As illustrated in FIG. 16, a void V is provided between the first core portion CR1 and the fourth core portion CR4. A void V is provided between the fourth core portion CR4 and the fifth core portion CR5. A void V is provided between the fifth core portion CR5 and the third core portion CR3. As illustrated in FIGS. 15 and 16, the first core CO1 defines a magnetic path. More specifically, the first core portion CR1 and the second core portion CR2 define a magnetic path through which a magnetic flux φ1 flows. The second core portion CR2 and the third core portion CR3 define a magnetic path through which a magnetic flux φ2 flows. The second core portion CR2 and the fourth core portion CR4 define a magnetic path through which a magnetic flux φ3 flows. The second core portion CR2 and the fifth core portion CR5 define a magnetic path through which a magnetic flux φ4 flows. The relationship φ=φ1+φ2+φ3+φ4 is satisfied. In the present modification, the area of a cross-section of the first core portion CR1 perpendicular or substantially perpendicular to the magnetic path, the area of a cross-section of the third core portion CR3 perpendicular or substantially perpendicular to the magnetic path, the area of a cross-section of the fourth core portion CR4 perpendicular or substantially perpendicular to the magnetic path, and the area of a cross-section of the fifth core portion CR5 perpendicular or substantially perpendicular to the magnetic path are each one-fourth the area of a cross-section of the second core portion CR2 perpendicular or substantially perpendicular to the magnetic path. The sum of the area of the cross-section of the first core portion CR1 perpendicular or substantially perpendicular to the magnetic path, the area of the cross-section of the third core portion CR3 perpendicular or substantially perpendicular to the magnetic path, the area of the cross-section of the fourth core portion CR4 perpendicular or substantially perpendicular to the magnetic path, and the area of the cross-section of the fifth core portion CR5 perpendicular or substantially perpendicular to the magnetic path is equal or substantially equal to the area of the cross-section of the second core portion CR2 perpendicular or substantially perpendicular to the magnetic path. Accordingly, the magnitude of the magnetic flux φ1, the magnitude of the magnetic flux φ2, the magnitude of the magnetic flux φ3, and the magnitude of the magnetic flux φ44 are each about one-fourth the magnetic flux φ. The number of core portions may be, for example, six or more.

The DC-DC converter 21f and the switching power supply 20f described above also achieve the same or substantially the same advantageous effects as the DC-DC converters 21a and 21e and the switching power supplies 20a and 20e. The DC-DC converter 21f can further reduce copper loss due to the winding LT11 compared to the DC-DC converter 21e. In other words, the DC-DC converter 21f can achieve a higher step-down ratio than the DC-DC converter 21e without increasing the number of turns of the winding LT11 and without increasing the area of the cross-section of the core portion perpendicular to the magnetic path.

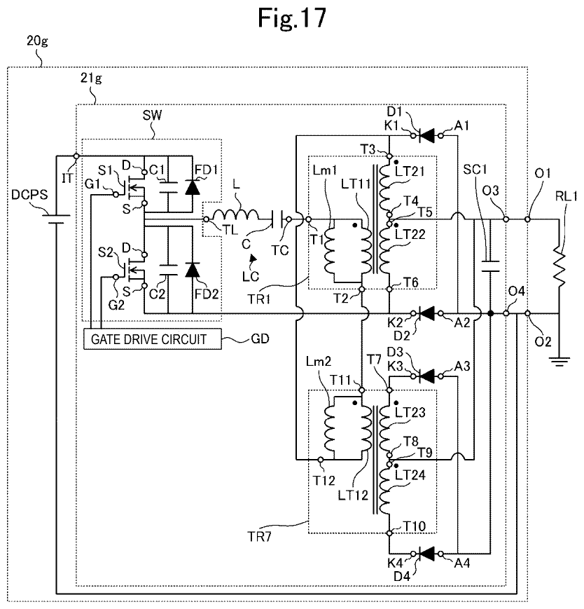

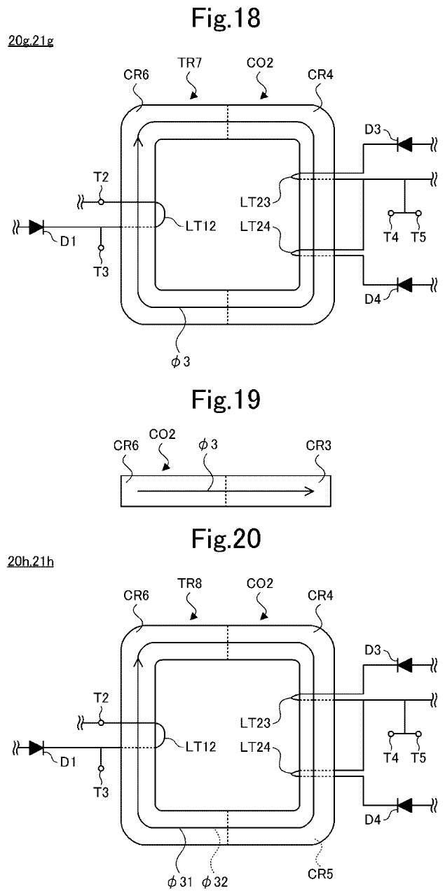

A DC-DC converter 21g and a switching power supply 20g according to a seventh modification of an example embodiment of the present invention are described below with reference to the drawings. FIG. 17 is a circuit diagram illustrating the switching power supply 20g including the DC-DC converter 21g, as well as a load resistance RL1. FIG. 18 is a sectional view schematically illustrating the structure of a transformer TR7, as well as the connections of the transformer TR7. FIG. 19 is a plan view schematically illustrating the structure of a second core CO2. The following description of the DC-DC converter 21g and the switching power supply 20g according to the seventh modification mainly focuses on features that differ from the DC-DC converter 21e and the switching power supply 20e according to the fifth modification, and the other descriptions thereof will be omitted.

The DC-DC converter 21g and the switching power supply 20g according to the seventh modification differ from the DC-DC converter 21e and switching power supply 20e according to the fifth modification in that transformers TR1 and TR7 are included instead of the transformer TR4. The structure of the transformer TR1 is the same or substantially the same as the structure of the transformer TR1 according to the first example embodiment, except that the area of a cross-section of the first core CO1 perpendicular or substantially perpendicular to the magnetic path is half the area of a cross-section of the first core CO1 of the first example embodiment perpendicular or substantially perpendicular to the magnetic path. The descriptions thereof therefore will be omitted.

In the circuit diagram illustrated in FIG. 17, the transformer TR7 includes a second excitation inductance Lm2 and windings LT12, LT23, and LT24. The windings LT12, LT23, and LT24 are magnetically coupled. The second excitation inductance Lm2 is an inductance that generates a magnetic flux φ12 that links all of the windings LT12, LT23, and LT24. In the transformer TR7, the direction of the magnetic flux φ12 generated when current flows from the one end T11 of the winding LT12 to the other end T12 of the winding LT12 coincides with the direction of the magnetic flux φ12 generated when current flows from the one end T7 of the winding LT23 to the other end T8 of the winding LT23, and the direction of the magnetic flux φ12 generated when current flows from the one end T9 of the winding LT24 to the other end T10 of the winding LT24. As a result, the windings LT12, LT23, and LT24 are magnetically positively coupled to one another. In the present modification, the turns ratio of the winding LT11 to the winding LT12 to the winding LT21 to the winding LT22 to the winding LT23 to the winding LT24 is, for example, about n/2:n/2:1:1:1:1, where n=2. However, n is not limited to 2. The turns ratio of the winding LT11 to the winding LT12 to the winding LT21 to the winding LT22 to the winding LT23 to the winding LT24 need not be, for example, n/2:n/2:1:1:1:1. The winding LT12 corresponds to a “sixth winding”. The winding LT23 corresponds to a “fourth winding”. The winding LT24 corresponds to a “fifth winding”.

The other end T2 of the winding LT11 is connected to one end T11 of the winding LT12. The other end T12 of the winding LT12 is connected to one end T3 of the winding LT21 and the first cathode K1. The one end T11 of the winding LT12 corresponds to a “twenty-fifth end”. The other end T12 of the winding LT12 corresponds to a “twenty-sixth end”.

In the sectional view illustrated in FIG. 18, the transformer TR7 includes the second core CO2 and the windings LT12, LT23, and LT24. The material of the second core CO2 is a magnetic material. The second core CO2 has a fourth core portion CR4 and a sixth core portion CR6. The windings LT23 and LT24 are each wound around the fourth core portion CR4. The winding LT12 is wound around the sixth core portion CR6. As illustrated in FIGS. 18 and 19, the second core CO2 defines a magnetic path. More specifically, the fourth core portion CR4 and the sixth core portion CR6 define a magnetic path through which a magnetic flux φ3 flows. In the present modification, the area of a cross-section of the second core CO2 perpendicular to the magnetic path is about half the area of a cross-section of the first core CO1 according to the first example embodiment perpendicular to the magnetic path. In the present modification, the area of a cross-section of the fourth core portion CR4 perpendicular or substantially perpendicular to the magnetic path is equal or substantially equal to the area of a cross-section of the sixth core portion CR6 perpendicular or substantially perpendicular to the magnetic path. An air gap may be provided between the fourth core portion CR4 and the sixth core portion CR6. The first core portion CR1 in the present modification corresponds to a “first core portion”. The second core portion CR2 in the present modification corresponds to a “second core portion”. The fourth core portion CR4 in the present modification corresponds to a “third core portion”. The sixth core portion CR6 in the present modification corresponds to a “fourth core portion”.

The DC-DC converter 21g and the switching power supply 20g described above also achieve the same or substantially the same advantageous effects as the DC-DC converter 21e and the switching power supply 20e.

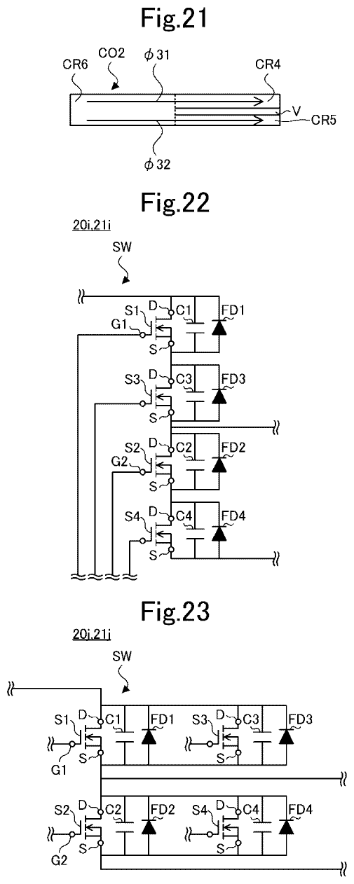

A DC-DC converter 21h and a switching power supply 20h according to an eighth modification of an example embodiment of the present invention are described below with reference to the drawings. FIG. 20 is a sectional view schematically illustrating the structure of a transformer TR8, as well as the connections of the transformer TR8. FIG. 21 is a plan view schematically illustrating the structure of a second core CO2. The following description of the DC-DC converter 21h and the switching power supply 20h according to the eighth modification mainly focuses on features that differ from the DC-DC converter 21f and the switching power supply 20f according to the seventh modification, and the other descriptions thereof will be omitted.

The DC-DC converter 21h and the switching power supply 20h according to the eighth modification differ from the DC-DC converter 21g and the switching power supply 20g according to the seventh modification in that a transformer TR2 is included instead of the transformer TR1, and that a transformer TR8 is included instead of the transformer TR7. The structure of the transformer TR2 is the same or substantially the same as the structure of the transformer TR2 according to the first modification, except that the area of a cross-section of the first core CO1 perpendicular or substantially perpendicular to the magnetic path is about half the area of a cross-section of the first core CO1 of the first modification perpendicular or substantially perpendicular to the magnetic path. The descriptions thereof therefore will be omitted.

As illustrated in FIG. 20, the second core CO2 further includes a fifth core portion CR5. This means that the second core CO2 includes three core portions. The winding LT23 is wound around the fourth core portion CR4. The winding LT24 is wound around the fifth core portion CR5. This means that the windings LT12, LT23, and LT24 are each wound around a respective different one of the three core portions of the second core CO2. As illustrated in FIG. 21, a void V is provided between the fourth core portion CR4 and the fifth core portion CR5. As illustrated in FIGS. 20 and 21, the second core CO2 defines a magnetic path. More specifically, the fourth core portion CR4 and the sixth core portion CR6 define a magnetic path through which a magnetic flux φ31 flows. The fifth core portion CR5 and the sixth core portion CR6 define a magnetic path through which a magnetic flux φ432 flows. The relationship φ3=φ31+φ32 is satisfied. In the present modification, the area of a cross-section of the fourth core portion CR4 perpendicular or substantially perpendicular to the magnetic path and the area of a cross-section of the fifth core portion CR5 perpendicular or substantially perpendicular to the magnetic path are each half the area of a cross-section of the sixth core portion CR6 perpendicular or substantially perpendicular to the magnetic path. The sum of the area of the cross-section of the fourth core portion CR4 perpendicular or substantially perpendicular to the magnetic path and the area of the cross-section of the fifth core portion CR5 perpendicular or substantially perpendicular to the magnetic path is equal or substantially equal to the area of the cross-section of the sixth core portion CR6 perpendicular or substantially perpendicular to the magnetic path. Accordingly, the magnitude of the magnetic flux φ31 and the magnitude of the magnetic flux φ32 are each about half the magnetic flux φ3. The second core CO2 may include four or more core portions.

The DC-DC converter 21h and the switching power supply 20h described above also achieve the same or substantially the same effects as the DC-DC converters 21 and 21a and the switching power supplies 20 and 20a. Specifically, the DC-DC converter 21h can further reduce copper loss due to the winding LT11. In other words, the DC-DC converter 21h can achieve a high step-down ratio without increasing the number of turns of the winding LT11 and without increasing the area of the cross-section of the core portion perpendicular to the magnetic path.

A DC-DC converter 21i and a switching power supply 20i according to a ninth modification of an example embodiment of the present invention are described below with reference to the drawings. FIG. 22 is a circuit diagram illustrating a switching circuit SW of the ninth modification. The following description of the DC-DC converter 211 and the switching power supply 201 according to the ninth modification mainly focuses on features that differ from the DC-DC converter 21 and the switching power supply 20 according to the first example embodiment, and the other descriptions thereof will be omitted.

As illustrated in FIG. 22, the switching circuit SW further includes a third switching element S3 connected in series with the first switch S1, and a fourth switching element S4 connected in series with the second switch S2. The on-period of the first switch S1 and the on-period of the third switching element S3 are the same or substantially the same. The on-period of the second switch S2 and the on-period of the fourth switching element S4 are the same or substantially the same. As a result, the upper limit of the first DC voltage Vin that can be input to the DC-DC converters 21 and 21a to 21h and the switching power supplies 20 and 20a to 20h can be increased. The third switching element S3 may include a parasitic capacitance C3 and a parasitic diode FD3. The fourth switching element S4 may include a parasitic capacitance C4 and a parasitic diode FD4. In the present modification, the first switch S1 and the third switching element S3 correspond to a “first switch”. The source S of the third switching element S3 corresponds to a “second end”. The second switch S2 and the fourth switching element S4 correspond to a “second switch”. The source S of the fourth switching element S4 corresponds to the “fourth end”.

A DC-DC converter 21j and a switching power supply 20j according to a tenth modification of an example embodiment of the present invention are described below with reference to the drawings. FIG. 23 is a circuit diagram illustrating a switching circuit SW of the tenth modification. The following description of the DC-DC converter 21j and the switching power supply 20j according to the tenth modification mainly focuses on features that differ from the DC-DC converter 21 and the switching power supply 20 according to the first example embodiment, and the other descriptions thereof will be omitted.

As illustrated in FIG. 23, the switching circuit SW further includes a third switching element S3 connected in parallel with the first switch S1, and a fourth switching element S4 connected in parallel with the second switch S2. The on-period of the first switch S1 and the on-period of the third switching element S3 are the same or substantially the same. The on-period of the second switch S2 and the on-period of the fourth switching element S4 are the same or substantially the same. As a result, the upper limit of current that can be input to the DC-DC converters 21 and 21a to 21h and the switching power supplies 20 and 20a to 20h can be increased. The third switching element S3 may include a parasitic capacitance C3 and a parasitic diode FD3. The fourth switching element S4 may include a parasitic capacitance C4 and a parasitic diode FD4. In the present modification, the first switch S1 and the third switching element S3 correspond to a “first switch”. The second switch S2 and the fourth switching element S4 correspond to a “second switch”.

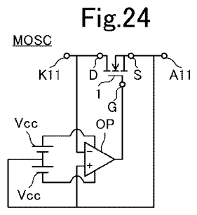

A DC-DC converter 21k and a switching power supply 20k according to an eleventh modification of an example of the present invention are described below with reference to the drawings. FIG. 24 is a circuit diagram illustrating a modification of a first rectifier. The following description of the DC-DC converter 21k and the switching power supply 20k according to the eleventh modification mainly focuses on features that differ from the DC-DC converter 21 and the switching power supply 20 according to the first example embodiment, and the other descriptions thereof will be omitted.

The DC-DC converter 21k and the switching power supply 20k according to the eleventh modification differ from the DC-DC converter 21 and the switching power supply 20 according to the first example embodiment in that, for example, a MOSFET rectifier MOSC is included instead of the first diode D1.

The MOSFET rectifier MOSC includes a MOSFET 1, an operational amplifier OP, and a DC power supply Vcc. When the electric potential at the drain D of the MOSFET 1 is lower than or equal to the electric potential at the source S of the MOSFET 1, the operational amplifier OP applies a positive voltage between the gate G and the source S of the MOSFET 1 to turn on the MOSFET 1. When the electric potential at the drain D of the MOSFET 1 is higher than the electric potential at the source S of the MOSFET 1, the operational amplifier OP does not apply a positive voltage between the gate G and the source S of the MOSFET 1 to turn off the MOSFET 1. This means that the MOSFET rectifier MOSC has the same or substantially the same function as the first diode D1. In the present modification, the MOSFET rectifier MOSC corresponds to a “first rectifier”. One end A11 of the MOSFET rectifier MOSC corresponds to a “thirteenth end”. The other end K11 of the MOSFET rectifier MOSC corresponds to a “fourteenth end”. By using a MOSFET with a low on-resistance as the MOSFET 1, the conduction loss generated by a “first rectifier” can be reduced.

As illustrated in the present modification, a “first rectifier” is not limited to a diode. Similarly, a “second rectifier,” a “third rectifier,” and a “fourth rectifier” are not limited to diodes.

The DC-DC converters according to example embodiments of the present invention are not limited to the DC-DC converters 21 and 21a to 21k, and can be modified within the scope of the present invention. The configurations of the DC-DC converters 21, 21a to 21k may be combined in any suitable manner.

The switching power supplies according to example embodiments of the present invention are not limited to the switching power supplies 20 and 20a to 20k, and can be modified within the scope of the present invention. The configurations of the switching power supplies 20, 20a to 20k may be combined in any suitable manner.

In the DC-DC converters 21 and 21a to 21k and the switching power supplies 20 and 20a to 20k, the switching circuit SW should not be configured as a full-bridge. If the switching circuit SW is configured as a full-bridge, the number of switching elements increases, which not only complicates the circuit configuration and control and increases losses, but also increases the size of the DC-DC converter and the switching power supply and makes it difficult to dissipate heat.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A DC-DC converter comprising:
a first switch including a first end and a second end, the first end being connected to a DC power supply;
a second switch including a third end and a fourth end, the third end being connected to the second end;
an LC series resonant circuit including a fifth end and a sixth end, the fifth end being connected to a connection point between the second end and the third end;
a conductor including a seventh end and an eighth end;
a first winding including a ninth end and a tenth end;
a second winding including an eleventh end and a twelfth end;
a first rectifier including a thirteenth end and a fourteenth end; and
a second rectifier including a fifteenth end and a sixteenth end, the fifteenth end being connected to the thirteenth end;
wherein the first winding and the second winding are magnetically positively coupled to each other;
the sixth end is connected to the seventh end;
the eighth end is connected to the ninth end and the fourteenth end;
the tenth end is connected to the eleventh end; and
the twelfth end is connected to the fourth end and the sixteenth end.

2. The DC-DC converter according to claim 1, wherein
the conductor defines a third winding; and
the first winding, the second winding, and the third winding are magnetically positively coupled to each other.

3. The DC-DC converter according to claim 1, further comprising:
a fourth winding including a seventeenth end and an eighteenth end;
a fifth winding including a nineteenth end and a twentieth end;
a third rectifier including a twenty-first end and a twenty-second end; and
a fourth rectifier including a twenty-third end and a twenty-fourth end, the twenty-third end being connected to the twenty-first end; wherein
the first winding, the second winding, the fourth winding, and the fifth winding are magnetically positively coupled to each other;
the seventeenth end is connected to the twenty-second end;
the eighteenth end is connected to the nineteenth end; and
the twentieth end is connected to the twenty-fourth end.

4. The DC-DC converter according to claim 1, further comprising:
a fourth winding including a seventeenth end and an eighteenth end;
a fifth winding including a nineteenth end and a twentieth end;
a third rectifier including a twenty-first end and a twenty-second end; and
a fourth rectifier including a twenty-third end and a twenty-fourth end, the twenty-third end being connected to the twenty-first end; wherein
the first winding, the second winding, the fourth winding, and the fifth winding are magnetically positively coupled to each other;
the seventeenth end is connected to the twenty-second end;
the eighteenth end is connected to the nineteenth end;
the twentieth end is connected to the twenty-fourth end;
a connection point between the eighteenth end and the nineteenth end is connected to a connection point between the tenth end and the eleventh end; and
a connection point between the twenty-first end and the twenty-third end is connected to a connection point between the thirteenth end and the fifteenth end.

5. The DC-DC converter according to claim 4, further comprising:
a core defining a magnetic path; wherein
the core includes:
a first core portion; and
a second core portion;
the first winding and the second winding are each wound around the first core portion; and
the fourth winding and the fifth winding are each wound around the second core portion.

6. The DC-DC converter according to claim 4, further comprising:
a core defining a magnetic path; wherein
the core includes five or more core portions; and
the first winding, the second winding, the fourth winding, and the fifth winding are each wound around a respective different one of the five or more core portions.

7. The DC-DC converter according to claim 1, wherein
the first rectifier and the second rectifier each include a diode;
the thirteenth end and the fifteenth end each includes an anode; and
the fourteenth end and the sixteenth end each include a cathode.

8. The DC-DC converter according to claim 3, wherein
the third rectifier and the fourth rectifier each include a diode;
the twenty-first end and the twenty-third end each include an anode; and
the twenty-second end and the twenty-fourth end each include a cathode.

9. The DC-DC converter according to claim 1, wherein
the first switch is closed while the second switch is open in a first period, the second switch is closed while the first switch is open in a second period, and the first period and the second period are repeated periodically;
in the first period, an electric potential at the ninth end differs from an electric potential at the fourth end; and
a DC voltage is output between a connection point between the tenth end and the eleventh end and a connection point between the thirteenth end and the fifteenth end.

10. The DC-DC converter according to claim 9, wherein a ratio of the first period to the second period is about 1:1.

11. A DC-DC converter comprising:
a first switch including a first end and a second end, the first end being connected to a DC power supply;
a second switch including a third end and a fourth end, the third end being connected to the second end;
an LC series resonant circuit including a fifth end and a sixth end, the fifth end being connected to a connection point between the second end and the third end;
a third winding including a seventh end and an eighth end;
a first winding including a ninth end and a tenth end;
a second winding including an eleventh end and a twelfth end;
a first rectifier including a thirteenth end and a fourteenth end;
a second rectifier including a fifteenth end and a sixteenth end, the fifteenth end of the second rectifier being connected to the thirteenth end;
a fourth winding including a seventeenth end and an eighteenth end;
a fifth winding including a nineteenth end and a twentieth end;
a sixth winding including a twenty-fifth end and a twenty-sixth end;
a third rectifier including a twenty-first end and a twenty-second end; and
a fourth rectifier including a twenty-third end and a twenty-fourth end, the twenty-third end being connected to the twenty-first end; wherein
the sixth end is connected to the seventh end;
the eighth end is connected to the twenty-fifth end;
the twenty-sixth end is connected to the ninth end and the fourteenth end;
the tenth end is connected to the eleventh end;
the twelfth end is connected to the fourth end and the sixteenth end;
the seventeenth end is connected to the twenty-second end;
the eighteenth end is connected to the nineteenth end;
the twentieth end is connected to the twenty-fourth end;
a connection point between the eighteenth end and the nineteenth end is connected to a connection point between the tenth end and the eleventh end; and
a connection point between the twenty-first end and the twenty-third end is connected to a connection point between the thirteenth end and the fifteenth end.

12. The DC-DC converter according to claim 11, further comprising:
a first core defining a magnetic path; and
a second core defining a magnetic path; wherein
the first core includes:
a first core portion; and
a second core portion;
the first winding and the second winding are each wound around the first core portion;
the third winding is wound around the second core portion;
the second core includes:
a third core portion; and
a fourth core portion;
the fourth winding and the fifth winding are each wound around the third core portion; and
the sixth winding is wound around the fourth core portion.

13. The DC-DC converter according to claim 11, further comprising:
a first core defining a magnetic path; and
a second core defining a magnetic path; wherein
the first core includes three or more core portions;
the first winding, the second winding, and the third winding are each wound around a respective different one of the three or more core portions of the first core;
the second core includes three or more core portions; and
the fourth winding, the fifth winding, and the sixth winding are each wound around a respective different one of the three or more different core portions of the second core.

14. The DC-DC converter according to claim 11, wherein
the first rectifier, the second rectifier, the third rectifier, and the fourth rectifier each include a diode;
the thirteenth end, the fifteenth end, the twenty-first end, and the twenty-third end each include an anode; and
the fourteenth end, the sixteenth end, the twenty-second end, and the twenty-fourth end each include a cathode.

15. The DC-DC converter according to claim 11, wherein
the first switch is closed while the second switch is open in a first period, the second switch is closed while the first switch is open in a second period, and the first period and the second period are repeated periodically;
in the first period, an electric potential at the twenty-sixth end differs from an electric potential at the fourth end; and
a DC voltage is output between the connection point between the tenth end and the eleventh end and the connection point between the thirteenth end and the fifteenth end.

16. The DC-DC converter according to claim 15, wherein a ratio of the first period to the second period is about 1:1.

17. A switching power supply comprising:
the DC-DC converter according to claim 1; and
the DC power supply.

18. The switching power supply according to claim 17, wherein
the conductor defines a third winding; and
the first winding, the second winding, and the third winding are magnetically positively coupled to each other.

19. A switching power supply comprising:
the DC-DC converter according to claim 11; and
the DC power supply.

20. The switching power supply according to claim 19, further comprising:
a first core defining a magnetic path; and
a second core defining a magnetic path; wherein
the first core includes:
a first core portion; and
a second core portion;
the first winding and the second winding are each wound around the first core portion;
the third winding is wound around the second core portion;
the second core includes:
a third core portion; and
a fourth core portion;
the fourth winding and the fifth winding are each wound around the third core portion; and
the sixth winding is wound around the fourth core portion.
